(19) United States
(12) Patent Application Publication
(10) Pub. No.: US 2018/0219510 A1
(43) Pub. Date: Aug. 2, 2018

(54) DISTRIBUTED LIGHT CONDENSATION/SPLITTING-BASED COMPREHENSIVE SOLAR ENERGY UTILIZATION SYSTEM

(71) Applicant: INSTITUTE OF ADVANCED TECHNOLOGY, UNIVERSITY OF SCIENCE AND TECHNOLOGY OF CHINA, Anhui (CN)

(72) Inventors: Wen LIU, Anhui (CN); Fangxin ZHANG, Anhui (CN); Dahan QIAN, Anhui (CN); Ming LI, Anhui (CN); Luqing LIU, Anhui (CN); Qixing WANG, Anhui (CN)

(73) Assignee: INSTITUTE OF ADVANCED TECHNOLOGY, UNIVERSITY OF SCIENCE AND TECHNOLOGY OF CHINA, Anhui (CN)

(21) Appl. No.: 15/751,989

(22) PCT Filed: Aug. 3, 2016
(86) PCT No.: PCT/CN2016/093030

§ 371 Date: Feb. 12, 2018

(30) Foreign Application Priority Data
Aug. 11, 2015 (CN) 201510490444.2

(51) Int. Cl. H02S 40/22; H02S 20/32; G02B 19/00; G02B 27/14; G02B 27/16

(52) U.S. Cl. CPC H02S 40/22; H02S 20/32; G02B 27/16; G02B 19/0028; G02B 27/141; G02B 19/0042

(57) ABSTRACT

The application proposes a distributed solar energy concentrating and splitting utilization system, comprising N concentrating and splitting optical modules, each of the concentrating and splitting modules comprising of a condensing mechanism, a splitting mechanism and a photovoltaic power generating device, wherein the splitting mechanism is located at the spotlight. The light receiving surface of the light condensing mechanism and the light receiving surface of the light splitting mechanism are oppositely arranged. The light splitting film is arranged on the light receiving surface of the light splitting mechanism, and a light transmitting hole is arranged on the light condensing mechanism for collecting sunlight and irradiating the light splitting mechanism. The light splitting mechanism is used to receive the sunlight condensed by the light converging mechanism and splitting light through the light splitting film, and the light transmitted through the light splitting mechanism is irradiated to the photovoltaic power generating device for photovoltaic power generation. The reflected light of the mechanism passes through the light transmission hole of the condenser mechanism. In the application, photovoltaic power generation is achieved through optical concentrating and spectroscopic methods and the basic requirements of plant lighting are satisfied, so that solar energy can be efficiently and comprehensively utilized.

### RELATED APPLICATIONS

This application claims the priority of Chinese Patent Application No. 201110490444.2 filed on Aug. 11, 2015 by the Chinese Patent Office with the title of a distributed solar collector system utilizing distributed spotlighting, the entire content of which is incorporated herein by reference.

### FIELD OF THE INVENTION

This application relates to the technical field of solar energy comprehensive utilization, and in particular to a solar energy utilization system of distributed spotlighting.

### BACKGROUND OF THE INVENTION

At present, the total area of cultivated agricultural facilities in China has reached the first place in the world. The appearance of greenhouse can make people eat fresh vegetables and fruits almost all year round, which greatly facilitates people's diet. In recent years, with the active promotion of agricultural machinery and other departments in various places, facilities and agriculture in China have witnessed a rapid development with remarkable social and economic benefits. On the other side, the photovoltaic industry is characterized by its renewability, sufficiency, safety and cleanliness. Many countries have successively invested a large amount of funds and promulgated various policies to support them. At present, the photovoltaic solar energy industry is in the outside lane of development, showing its continuous improvement in output and the solar cell unit prices continue to decline. Accordingly to statistics, the global solar cell production capacity has reached in 2011 37.2 GW, of which China's production has more than half of the world's total output.

In this context, a variety of solar-assisted greenhouses emerge as the times require, especially with the development of LED lighting. With the improvement of LED photoelectric conversion efficiency and the decrease of price, the combination of LED and photovoltaic power generation is complementing each other. The LED needs a DC drive and the solar battery output is DC. Thus, the DC output of PV does not need to go through the inverter to AC and can directly be supplied to the LED. Energy loss during DC/AC inversion is prevented.

The current solar assisted lighting greenhouses have the problem of low comprehensive utilization efficiency of solar energy, mainly in the following aspects: the orientation of the solar cell is fixed, the light receiving area varies greatly in different time segments, and the fixed solar energy orientation cannot satisfy all the regions. The light-receiving direction of the segment brings along a comprehensive problem of low energy efficiency. The photovoltaic panels on the greenhouses are only used for lighting. All the wavelength bands from the sun are used to generate electricity. The plants in the greenhouses under the photovoltaic panels cannot obtain the necessary light. As a solution the number of photovoltaic panels installed on the greenhouse is limited and reduced but the plant growth will still be negatively affected.

Therefore, it has become an urgent technical challenge to develop a comprehensive system that can do both, take care of the plant growth in the greenhouse and achieve simultaneously efficient solar energy generation. Chinese patent CN103997285A discloses a comprehensive solar energy utilization system for plant greenhouses, which solves the problem of low utilization efficiency of regular solar energy greenhouse systems. However, the above spectral spectroscopic characteristics of the system does not focus on the case of light splitting. The required spectral splitting mechanism is in indeed larger, which may result in greater pressure on overall costs.

### SUMMARY OF THE INVENTION

To solve the technical problems existing in the current systems, the present application proposes a solar energy utilization system of distributed spotlighting. It performs photovoltaic power generation via optical concentration and simultaneously meets via spectroscopic methods the basic requirements for plant lighting. This way the system achieves a very energy efficient

The solar energy utilization system with distributed concentrating and splitting technique proposed in the present application comprises of N concentrating and splitting modules. Each concentrating and splitting module comprises of a light condensing mechanism, a light splitting mechanism and a photovoltaic power generating device. The light splitting mechanism is located at the spotlight. The light receiving surface of the light condensing mechanism and the light receiving surface of the light splitting mechanism are opposite to each other. A light splitting film is arranged on the light receiving surface of the light splitting mechanism. The light penetrating opening K is arranged on the light condensing mechanism for collecting sunlight and irradiating on the light splitting mechanism, the light splitting mechanism is used for receiving the sunlight condensed by the light converging mechanism and splitting the light through the light splitting film; the transmitted light of the light splitting mechanism is irradiated onto the photovoltaic power generating device for photovoltaic power generation. The reflected light of the light splitting mechanism passes through the light transmissive opening K of the light condensing mechanism.

Preferably, the light concentrating mechanism, the light splitting mechanism and the photovoltaic power generating device are connected by a connecting rod to form a light concentrating light splitting module.

Preferably, the light receiving surface of the light condensing mechanism is a butterfly curved surface, and/or the light receiving surface of the light splitting mechanism is a butterfly curved surface.

Preferably, the central axes of the light concentrating mechanism and the light splitting mechanism are on the same straight line, and the light transmitting hole K is disposed coaxially with the light concentrating mechanism.

Preferably, the photovoltaic power generation device is on the same straight line as the central axis of the light concentrating mechanism and the light splitting mechanism.

Preferably, the convergent light converged by the light concentrating mechanism all falls on the light splitting mechanism, and/or all the transmitted light split by the light splitting mechanism falls on the photovoltaic power generation device.

Preferably, the light concentrating and splitting module furthermore comprises a light diffusing plate. The light diffusing plate is installed at the light transmitting hole K of the light condensing mechanism. The light diffusing plate is used to receive the light reflected by the light splitting mechanism and evenly scatters the reflected light.

Preferably, the light condensing mechanism adopts tempered ultra-white glass or chemically toughened glass, and the light-receiving surface is coated.

Preferably, the light splitting mechanism adopts a dichroic mirror, the dichroic mirror is a butterfly curved surface structure, and the light splitting film covers the surface of the dichroic mirror.

Preferably, the dichroic mirror is made of a hard and transparent material, and the light-splitting film adopts a photonic crystal film, a multilayer dielectric film or a multilayer organic polymer film.

Preferably, the spectral film is used to reflect light of a predetermined wavelength range and transmit light of the remaining wavelength range.

Preferably, the reflection characteristic of the spectral film is designed accordingly to an absorption spectrum required for plant growth. The reflection characteristic comprises a reflection spectrum, a reflected light intensity and a reflection bandwidth. The light reflected by the spectral film is in a predetermined wavelength range and includes blue light and red light.

Preferably, N concentrator modules are arranged in an array of X×Y, where X×Y=N. Preferably, a tracking module is furthermore included. The tracking module is connected to the light condensing mechanism of the N light collecting and splitting modules, and the tracking module is used to adjust the position of the light condensing mechanism accordingly to the incident angle of sunlight.

Preferably, the tracking module includes a first tracking module, the first tracking module includes N gimbal shafts, N first adjusting rods, and a first driving mechanism. The first driving rod, the X first transmission rods and the N light collecting mechanisms are fixed on the N gimbal shafts. The N first adjusting rods are connected with the N condensing mechanisms. The Y first adjusting rods are connected with the Y condensing mechanisms in the same row in the array which are all connected with the same first transmitting rod. The X first gears rods are each connected to a first drive rod, which is connected to the first drive mechanism.

Preferably, the tracking module furthermore comprises of a second tracking module, and the second tracking module comprises of N second adjusting rods, a second driving mechanism, a second driving rod and Y second driving rods. The N second adjusting rods are connected to the N light condensing mechanisms, and the first adjusting rods and the second adjusting rods are connected to any one of the light converging mechanisms which have a predetermined included angle. The X second adjusting rods are connected to the X condensing mechanisms in the same row in the array which are all connected to one and the same second driving rod. The Y second driving rods are both connected to the second driving rod. The second driving rod is connected with the second driving mechanism.

In the present application, the light concentrating and splitting modules include each a light condensing mechanism, a light splitting mechanism, and a photovoltaic power generation device. The light splitting mechanism is located between the light condensing mechanism and the photovoltaic power generating device. The light receiving surface of the light condensing mechanism and the light receiving surface of the light splitting mechanism are oppositely aligned. A light splitting film is provided on a light receiving surface of the light splitting mechanism, and a light transmitting hole is formed on the light condensing mechanism. The light concentrating mechanism is used to converge the sunlight and irradiate it on the light splitting mechanism. The light splitting mechanism is used to receive the sunlight condensed by the light concentrating mechanism and disperse the light through the light splitting film. Specifically, the light-splitting film reflects light in a predetermined wavelength range for photovoltaic power generation and transmits light in the remaining wavelength range for plant growth. The transmitted light of the light splitting mechanism is irradiated to the photovoltaic power generation device for photovoltaic power generation. The reflected light of the light splitting mechanism passes through the light-transmissive holes of the light concentrating mechanism and irradiates the plants for plant growth.

In the present application, the light condensing mechanism is located at the bottom, the photovoltaic power generation device is located at the top, and the light splitting mechanism is located between the light condensing mechanism and the photovoltaic power generation device. Through the light gathering mechanism, the sunlight is collected, and then the collected sunlight is dispersed by the light splitting mechanism. A part of the sunlight is transmitted to the photovoltaic power generation device through the light splitting mechanism for photovoltaic power generation, and the other part of the sunlight is reflected to the light transmissivity through the light splitting mechanism Hole and shines on plants for plant growth. In this way, one achieves not only photovoltaic power generation but also meets the basic needs of plant lighting achieving overall efficient and comprehensive utilization of solar energy.

Solar energy utilization system, due to the use of the first condenser beam splitting design, can greatly reduce the use of spectral film area, to achieve a substantial reduction in the cost of splitting; so, one can use higher cost but more complex structures of the multilayer film design. This solar energy utilization system is more economical.

In the present application, the light condensing mechanism and the light splitting mechanism adopt a butterfly curved surface structure. It ensures that the sunlight gathered by the light condensing mechanism can fall on the light splitting mechanism. It also ensures that the reflected light from the light splitting mechanism can converge to the light transmissive hole and then irradiate the plants.

### BRIEF DESCRIPTION OF DRAWINGS

FIG. 1 is an optical schematic diagram of a distributed solar energy utilization system for concentrating and redistributing light in the present application.

FIG. 2 is a top view of a distributed solar concentrating and splitting solar energy utilization system proposed in the present application.

FIG. 3 is a schematic front view of a mounting structure of a distributed solar energy utilization system for concentrating and splitting light proposed by the present application.

FIG. 4 is a schematic side view of a mounting structure of a distributed solar energy utilization system for concentrating and splitting light proposed in the present application.

FIG. 5 is a top view of a mounting structure of a distributed solar energy utilization system for concentrating and splitting light proposed by the present application.

FIG. 6 is a schematic structural diagram of a specific embodiment of a distributed solar energy utilization system for concentrating and splitting light proposed in the present application.

### DETAILED DESCRIPTION OF EMBODIMENTS

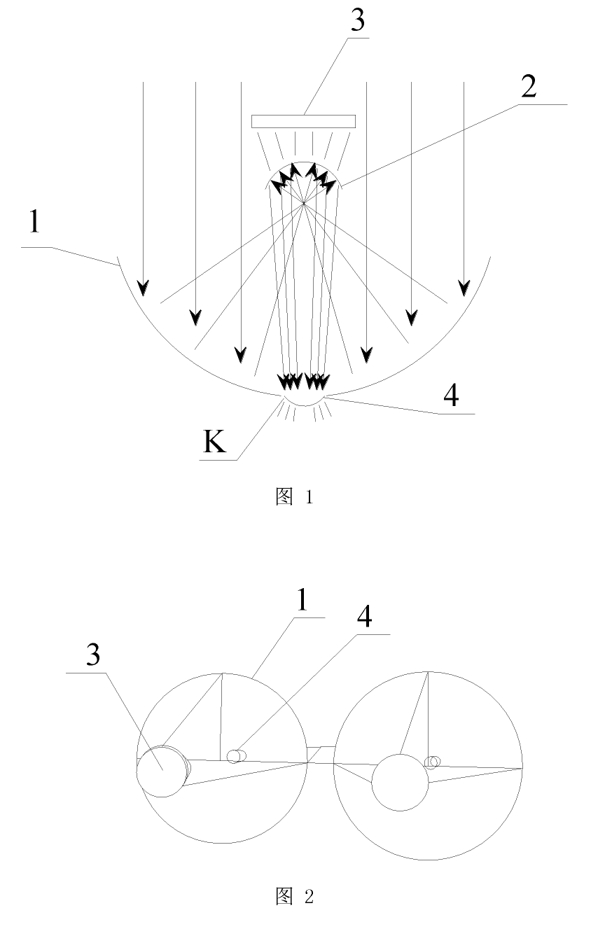

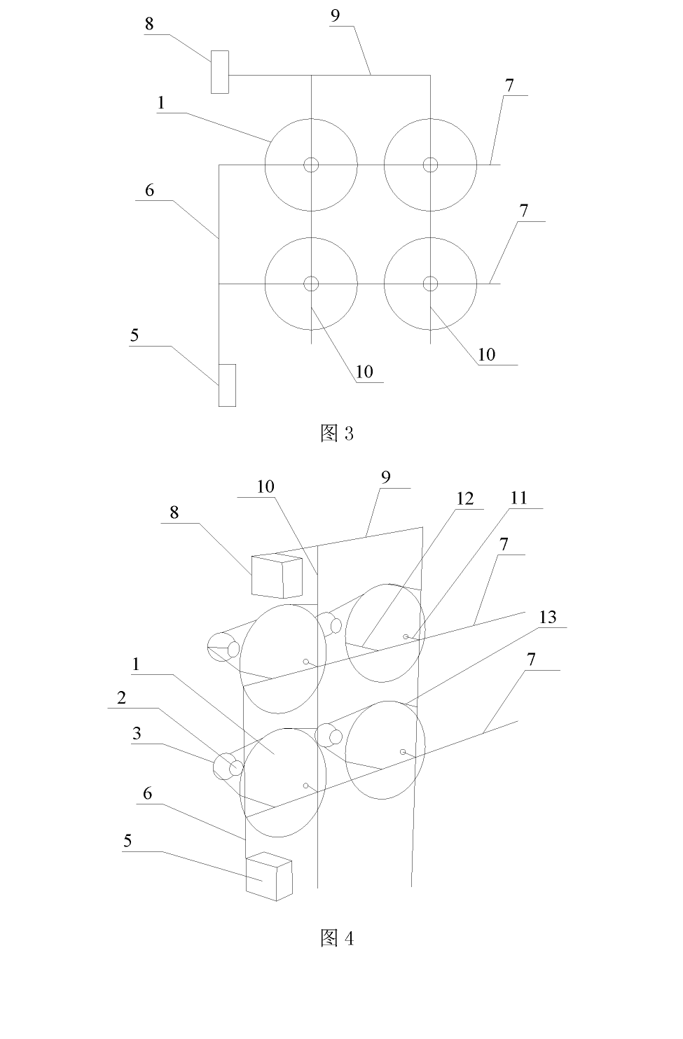

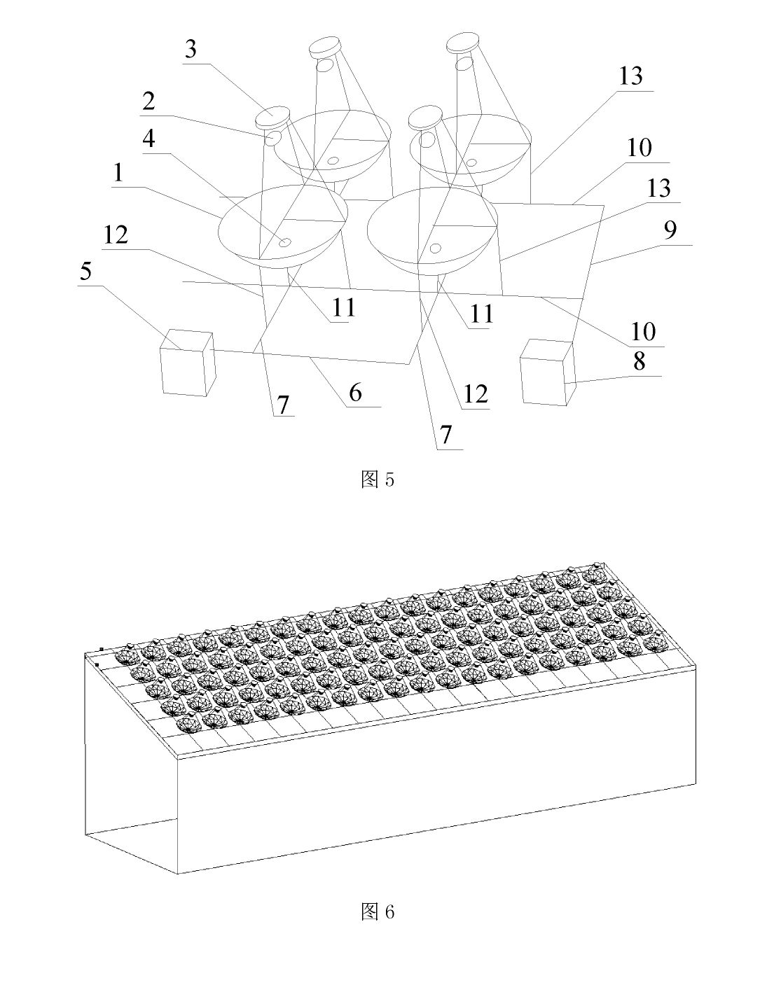

Referring to FIG. 1, FIG. 2, FIG. 3, FIG. 4, and FIG. 5, the present application proposes a distributed solar concentrating and splitting solar energy utilization system. Including N condenser optical modules, N is an integer, and the condenser optical module includes a condenser 1, a spectroscopic unit 2 and a photovoltaic generator 3. The light splitting mechanism 2 is located between the light concentrating mechanism 1 and the photovoltaic power generation device 3. The light receiving surface of the light concentrating mechanism 1 and the light receiving surface of the light splitting mechanism 2 are opposed to each other. A light-splitting film is provided on the light-receiving surface of the spectroscopic mechanism 2, and a light-transmitting hole K is provided in the light-condensing mechanism 1.

The light concentrating mechanism 1 is configured to condense sunlight and irradiate it to the light splitting mechanism 2. The light splitting mechanism 2 is configured to receive the sunlight condensed by the light concentrating mechanism 1 and then disperse the light through the light splitting film. Specifically, the spectral film reflects light in a predetermined wavelength range and transmits light in the remaining wavelength range. The transmitted light via the beam splitter 2 is irradiated onto the photovoltaic cell device for photovoltaic power generation. The reflected light from the beam splitter 2 passes through the light-transmitting hole K of the light-condensing mechanism 2 and is irradiated onto the plant for plant growth.

In this embodiment of the present application, the sunlight is collected by the light concentrating mechanism 1, and the collected sunlight is dispersed by the light splitting mechanism 2. A part of the sunlight is transmitted to the photovoltaic power generation device 3 through the light splitting mechanism 2 for photovoltaic power generation and the other part of the sunlight is reflected by the light splitting mechanism 2 to the light transmitting hole K and passes through the light transmitting hole K to irradiate the plants for plant growth. It allows not only photovoltaic power generation but also meets the basic needs of plant lighting, the solar energy is efficiently utilized.

The presented solar energy utilization system, due to the use of the first condenser beam splitting design, can greatly reduce the use of spectral film area, to achieve a substantial reduction in the cost of light splitting; so, one can accept the higher cost but use more complex structure of the multilayer film design. So, this solar energy utilization system is more economical.

As shown in FIG. 1, in the embodiment of the present application, the light splitting mechanism 2 and the photovoltaic power generator 3 can be mounted on the light condensing mechanism 1 through a connecting rod during actual installation. In this way, the light concentrating mechanism 1, the light splitting mechanism 2 and the photovoltaic power generating device 3 form a light concentrating light splitting module for concentrating and splitting light.

As shown in FIG. 1, in the embodiment of the present application, to utilize solar energy more effectively, the light-receiving surface of the light-condensing mechanism 1 is a butterfly-shaped curved surface, and the light-receiving surface of the light splitting mechanism 2 is a butterfly-shaped curved surface. The central axes of the light concentrating mechanism 1, the light splitting mechanism 2 and the photovoltaic power generator 3 are in the same straight line. The light transmission hole K is disposed coaxially with the light condensing mechanism 1, and the light transmission hole K is a circular hole provided on the central axis of the light condensing mechanism 1.

In this application, by providing the light-receiving surface of the light-condensing mechanism 1 as a butterfly curved surface, it is ensured that the light-condensing mechanism 1 can converge the sunlight and fall on the light-splitting mechanism 2. By providing the light-receiving surface of the light splitting mechanism 2 as a butterfly-shaped curved surface, it is ensured that the light reflected by the light splitting mechanism 2 can converge on the light-transmissive hole K and irradiate the plants.

By controlling the relative positions and sizes of the light concentrating mechanism 1 and the light splitting mechanism 2, all the converged light collected by the light concentrating mechanism 1 falls on the light splitting mechanism 2. By controlling the relative position and size of the photovoltaic power generation device 3, the transmitted light split by the light splitting mechanism 2 falls entirely on the photovoltaic power generation device 3, so that the photovoltaic power generation by the transmitted light of the light splitting mechanism 2 can be guaranteed to the maximum extent.

To ensure that the reflected light collected at the light transmitting hole K can be evenly irradiated onto the plants, a diffuser plate 4 is embedded in the light transmitting hole K. The light-scattering plate 4 is used to receive the reflected light from the light splitting mechanism 2 and evenly scatters the reflected light to irradiate the plant more widely for plant growth.

In the embodiment of the present application, the light converging mechanism 1 is made of tempered ultra-clear glass or chemically tempered glass, and the light-receiving surface is silver-plated. The condensing mechanism 1 has a condensing magnification of 10×-100×.

In this embodiment, the light splitting mechanism 2 includes a beam splitter, the beam splitter is a butterfly curved surface structure, and the light splitting film covers the surface of the dichroic mirror. Beam splitters are made of hard, transparent materials such as hard and transparent plastic, glass and else material. The photoluminescence film uses a photonic crystal film, a multilayer dielectric film or a multilayer organic polymer film. The film is covered on the surface of the beam splitter by means of pasting or vacuum coating.

In practical applications, the reflection characteristics of the spectral film are designed accordingly to the absorption spectra required for the growth of different plants. The reflection characteristics include the reflection spectrum, the reflected light intensity and the reflection bandwidth. The light reflected by the spectral film is in a predetermined wavelength range and includes plant-friendly light such as blue light and red light. For example, blue light at a wavelength of 430+/−20 nanometers and red light at a wavelength of 650+/−20 nanometers.

The photovoltaic power generation device 3 adopts a single-crystal back gate electrode photovoltaic chip or a multi-junction wide-spectrum solar cell.

Broad-spectrum solar cells use III-V materials such as InGaP/GaAs/Ge. Accordingly, to the condensing magnification of the focusing mechanism 1, the photovoltaic power generation device 3 is selected as the heat dissipation method, and the heat dissipation method includes passive heat dissipation method and water cooling or air cooling light active heat dissipation methods.

As shown in FIG. 3, FIG. 4, FIG. 5, and FIG. 6, in this embodiment, N concentrating, and dispersing modules are arranged in an array of X×Y, where X×Y=N.

In the above embodiment, when the light converging mechanism 1 of the light converging and splitting module converges the light, the focal length of the light converging surface varies with the incident angle of the sunlight. This will make it impossible for the condensing focal plane to fall on or fail to fall on the light splitting mechanism 2 at a better angle to affect the reflection and transmission of the light splitting mechanism 2 to be unable to utilize or make better use of the sunlight.

Therefore, based on the above embodiments, the solar energy utilization system of the present application furthermore includes a tracking module. The tracking module is connected with the light condensing mechanism 1 of the N concentrating and demultiplexing modules, and the tracking module is used to adjust the position of the condensing mechanism 1 accordingly to the incident angle of the sunlight to realize that the condensing mechanism 1 always tracks the sun. The light is continuously tracked by the light concentrating mechanism 1 at various times and the light concentrating mechanism 1 can be automatically tracked along the sun track in east, west and north directions at various times, and the light concentrating mechanism 1 can converge the sunlight on the light splitting mechanism 2 at the optimal angle. So that all the reflected light of the light splitting mechanism 2 is reflected on the diffuser 4 to achieve the maximum effective utilization of the solar energy.

As shown in FIG. 3, FIG. 4, FIG. 5 and FIG. 6, in this embodiment, the tracking module includes a first tracking module and a second tracking module.

The first tracking module includes N gimbal shafts 11, N first adjusting rods 12, a first driving mechanism 5, a first driving rod 6 and X first driving rods 7. The N light concentrating mechanisms 1 are respectively fixed on the N gimbal shafts 11, and the N first adjusting rods 12 are respectively connected to the N light condensing mechanisms 1. The Y first adjusting rods 12 connected to the Y condensing mechanisms 1 in the same row in the array are all connected to the same first transmitting rod 7. Each of the X first transmission rods 7 is connected to the first driving rod 6, and the first driving rod 6 is connected to the first driving mechanism 5.

The second tracking module includes N second adjusting rods 13, a second driving mechanism 8, a second driving rod 9 and Y second driving rods 10. The connection point between the first adjusting rod 12 connected to any one of the light concentrating mechanisms 1 and the light condensing mechanism 1 and the connection point between the second adjusting rod 13 connected to the light condensing mechanism 1 and the light condensing mechanism 1 have a predetermined angle. The N second adjusting rods 13 are connected with the N light condensing mechanisms 1 and the X second adjusting rods 13 connected with the X condensing mechanisms 1 in the same column in the array are all connected with the same second transmitting rod 10, Y second transmission rods 10 are connected to the second driving rod 9, and the second driving rod 9 is connected to the second driving mechanism 8.

In a specific application, the first drive mechanism 5 and the second drive mechanism 8 both adopt a double-axis tracking motor.

The first driving mechanism 5 drives the first driving rod 6 to drive the first transmission rod 7 on the X rows in the array to rotate and the first transmission rod 7 drives the Y light condensing mechanisms 1 on the X rows to rotate so as to adjust Y Poly Angle of light mechanism 1 in the east-west direction. The second driving mechanism 8 drives the second driving rod 9 to drive the second transmission rod 10 in row Y in the array to rotate. The second transmission rod 10 drives the X light condensing mechanisms 1 in row Y to rotate to adjust the north-south direction angles of the X light condensing mechanisms 1 in row Y. The position of the light converging mechanism 1 is adjusted by the tracking module accordingly to the incident angle of the sunlight so that the light concentrating mechanism 1 can track the sun always to achieve the effect of fully utilizing the solar energy.

The solar energy utilization system of the distributed spotlighting and splitting proposed by the present application converges sunlight by the light concentrating mechanism 1 and then disperses the concentrated sunlight by the light splitting mechanism 2. A part of the sunlight is transmitted to the photovoltaic power generation device 3 through the light splitting mechanism 2 for photovoltaic power generation, and the other part of the sunlight is reflected by the light splitting mechanism 2 to the light transmissive hole and irradiates the plants for plant growth. In this way, not only photovoltaic power generation can meet the basic needs of plant lighting, solar energy achieves efficient utilization.

Solar energy utilization system, due to the use of the first condenser beam splitting design, can greatly reduce the use of spectral film area, to achieve a substantial reduction in the cost of splitting; so, you can use the higher cost but more complex structure of the multilayer film design. So, this solar energy utilization system is more economical.

By arranging the tracking module, the light gathering mechanism 1 can track the sun always, and at separate times, the light concentrating mechanism 1 can track the things and the north-south directions automatically accordingly to the sun's trajectory. The light concentrating mechanism 1 can converge the sunlight on the light splitting mechanism 2 at an optimal angle so that the light reflected by the light splitting mechanism 2 is totally reflected on the light diffusing plate 4 to achieve maximum and effective utilization of the solar energy.

The foregoing descriptions are merely preferred specific embodiments of the present application, but the protection scope of the present application is not limited thereto. Any equivalent replacement or change made by those skilled in the art within the technical scope disclosed in the present application according to the technical solutions of the present application and the concept of the application thereof shall fall within the protection scope of the present application.

1. A distributed solar energy concentrating and splitting utilization system, comprising:
N light concentrating and splitting modules, each light concentrating and splitting module comprising a condensing mechanism, a light splitting mechanism and a photovoltaic power generator;
wherein:
the light splitting mechanism is located between the light condensing mechanism and the photovoltaic power generation device, and a light receiving surface of the light condensing mechanism is opposite to a light receiving surface of the light splitting mechanism;
a light splitting film is arranged on the light receiving surface of the light splitting mechanism;
the light condensing mechanism having a light transmitting opening K;
the light condensing mechanism is configured to condense sunlight and direct onto the light splitting mechanism, which is used to receive the sunlight condensed by the light concentrating mechanism and disperse the light through the light splitting film;
the transmitted light is directed to the photovoltaic power generation device via the light splitting mechanism for photovoltaic power generation;
the reflected light of the light splitting mechanism passes through the light transmitting opening K of the light condensing mechanism.

2. The system of claim 1, wherein the light condensing mechanism, the light splitting mechanism and the photovoltaic power generator are connected by a connecting rod to form the light splitting module.

3. The system of claim 1, wherein at least one of the light receiving surface of the light condensing mechanism and the light receiving surface of the light splitting mechanism is a butterfly curved surface.

4. The system of claim 1, wherein central axes of the light concentrating mechanism and the light splitting mechanism are on the same straight line, and the light transmitting opening K is disposed coaxially with the light condensing mechanism.

5. The system of claim 1, wherein the photovoltaic power generator is on the same straight line as a central axis of the light condensing mechanism and the light splitting mechanism.

6. The system of claim 1, being configured so that at least one of the following is performed:
all convergent light converged by the light condensing mechanism is directed to the light splitting mechanism;
all transmitted light split by the light splitting mechanism is directed to the photovoltaic power generator.

7. The system of claim 1, wherein the light concentrating and splitting module further comprises a light diffusing plate installed at the light transmitting opening K of the light condensing mechanism, thereby receiving reflected light from the light splitting mechanism and evenly scattering the reflected light.

8. The system of claim 1, wherein the light condensing mechanism is made of tempered ultra-white glass or chemical tempered glass, and the light-receiving surface is coated.

9. The system of claim 1, wherein the light splitting mechanism is a beam splitter, having a butterfly curved surface, with a spectral film covering the butterfly curved surface.

10. The system of claim 9, wherein the beam splitter is made of a hard and transparent material, and the spectral film is a photonic crystal film, a multilayer dielectric film or a multilayer organic polymer film.

11. The system of claim 1, wherein the spectral film is configured to reflect light in a predetermined wavelength range and transmit light in the remaining wavelength range.

12. The system of claim 11, wherein the spectral film is configured to reflect blue light and red light in a predetermined wavelength range.

13. The system of claim 1, wherein N light concentrating and splitting modules are arranged in an array of X×Y, where X×Y=N.

14. The system of claim 1, further comprising a tracking module, connected with the light condensing mechanism for adjusting a position of the light condensing mechanism according to an incident angle of sunlight. 15, The system of claim 14, wherein the tracking module comprises a first tracking module, the first tracking module comprising N gimbal shafts, N first adjusting rods, and a first driving mechanism;
the first driving rod, the X first transmission rods and the N light collecting mechanisms are fixed on the N gimbal shafts;
the N first adjusting rods are connected with the N condensing mechanisms;
the Y first adjusting rods are connected with the Y condensing mechanisms in the same row in an array which are all connected with the same first transmitting rod;
the X first gears rods are each connected to a first drive rod, which is connected to the first drive mechanism.

16. The system of claim 14, wherein the tracking module further comprises a second tracking module comprising N second adjustment rods, a second driving mechanism, a second driving rod and Y second driving rods;
the N second adjusting rods are connected to the N light condensing mechanisms;
the first adjusting rods and the second adjusting rods are connected to any one of the light condensing mechanisms which have a predetermined angle;
the X second adjusting rods are connected to the X condensing mechanisms in the same row in an array which are all connected to one and the same second driving rod;
the Y second driving rods are both connected to the second driving rod; and
the second driving rod is connected with the second driving mechanism.
